(19) United States
(12) Patent Application Publication
(10) Pub. No.: US 2003/0071068 A1
(43) Pub. Date: Apr. 17, 2003

(54) Illuminated water cooler

(76) Inventor: Bruce D. Burrows, Santa Clarita, CA (US)

Correspondence Address: Stuart O. Lowry, KELLY BAUERSFELD LOWRY & KELLEY, LLP, Suite 1650, 6320 Canoga Avenue, Woodland Hills, CA, 91367, US

(21) Appl. No.: 10/265,091

(22) Filed: Oct. 3, 2002

Related U.S. Application Data
(60) Provisional application No. 60/327,274, filed on Oct. 3, 2001.

(51) Int. Cl. B67D 5/06

(52) U.S. Cl. 222/185.1

(57) ABSTRACT

A bottled water cooler includes at least one and preferably a plurality of lights for illuminating a transparent water bottle mounted onto a cooler housing in an inverted orientation. The lights are mounted on the cooler housing for illuminating the bottle generally at a bottle shoulder along an annular contact zone supported on the cooler housing. The lights shine generally upwardly through the transparent bottle wall and into the bottle interior to illuminate the bottle and its contents, resulting in an attractive and refreshing appearance.

### BACKGROUND OF THE INVENTION

This application claims the benefit of U.S. Provisional Application No. 60/327,274, filed Oct. 3, 2001.

This invention relates generally to improvements in bottled water dispensing stations or coolers of the type adapted to receive and support a water bottle in an inverted position, and to selectively dispense water therefrom. More specifically, this invention relates to an improved bottled water cooler having means for illuminating the inverted water bottle and its contents to provide a highly pleasing and refreshing appearance.

Bottled water dispensing stations, commonly referred as bottled water coolers, are well known in the art for containing a supply of relatively purified water in a convenient manner and location ready for substantially immediate dispensing and use. Such bottled water coolers commonly include an upwardly open reservoir mounted on or within a cooler housing and adapted to receive and support an inverted water bottle of typically three to five gallon capacity. Water within the inverted bottle flows downwardly into the cooler reservoir for selective dispensing therefrom through a faucet valve mounted on the front of the cooler housing. In many cooler designs, refrigeration means such as a conventional mechanical refrigeration system or a compact thermoelectric chiller module are provided for maintaining the water within the reservoir at a refreshing chilled temperature. Moreover, in one common configuration, the reservoir interior may be subdivided into a first chamber chilled by the refrigeration means and a second chamber wherein the water is maintained substantially at room temperature, with separate faucet valves being provided for separately dispensing the water from these chambers. Bottled water coolers of the type generally described above are widely used to provide a clean and safe source of water for drinking and cooking, especially in areas wherein the local water supply may be suspected to contain undesirable levels of contaminants.

In use, water from within the inverted water bottle flows downwardly through an open-mouthed bottle neck into the underlying cooler reservoir, with a corresponding volume of air being drawn upwardly into the bottle to replace the displaced water. As the reservoir fills with water, the water level therein rises and eventually covers the bottle mouth to halt further air intake whereby a sufficient vacuum develops within the bottle to correspondingly halt water downflow. Dispensing of water from the reservoir causes the water level therein to descend and uncover the bottle mouth, at which time air intake into the bottle and water downflow from the bottle resumes to refill the reservoir until the reservoir water level rises again to re-cover the bottle mouth. The upward flow of air into the bottle takes the form of air bubbles passing upwardly through the water remaining in the bottle, wherein this upward air flow is externally visible through the typically transparent wall of the water bottle. When the inverted bottle reaches an empty condition, the bottle is removed from the cooler and replaced by a filled bottle.

The present invention relates to a lighting arrangement for illuminating the water bottle and the remaining water and replacement air bubbles therein, to provide a water cooler having an attractive and refreshing appearance.

### SUMMARY OF THE INVENTION

In accordance with the invention, a bottled water cooler includes at least one and preferably a plurality of lights for illuminating a transparent water bottle mounted onto a cooler housing in an inverted orientation. The lights shine generally upwardly through the transparent bottle wall and into the bottle interior to illuminate the bottle and its contents, resulting in an attractive and refreshing appearance.

In a preferred form of the invention, the at least one light comprises a plurality of lights such as low voltage LED's mounted on the cooler housing for illuminating the inverted bottle generally at a bottle shoulder along an annular contact zone supported on the cooler housing. In a preferred configuration, the lights are individually mounted within an upstanding support rim on the cooler such as on a housing cover or lid, wherein the support rim is designed for engaging and supporting the shoulder of the inverted water bottle. The lights are mounted in individual positions aligned with respective ports formed in the support rim at locations adjacent to or in close proximity with an annular or generally annular contact zone of the bottle shoulder, when the bottle is mounted onto the water cooler in an inverted orientation. With this construction, the lights shine through the respective ports to illuminate the bottle and further shine through the transparent bottle material to illuminate the bottle contents including the water and any air bubbles therein. The lights can be provided in the same or different colors.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a front perspective view of a bottled water cooler embodying the novel features of the invention, and illustrating an inverted water bottle in exploded relation with the cooler;

FIG. 2 is an enlarged and fragmented top perspective view of the water cooler of FIG. 1;

FIG. 3 is an exploded perspective view of a bottle support rim having a plurality of lights mounted thereon; and

FIG. 4 is an enlarged and fragmented vertical sectional view taken generally on the line 4-4 of FIG. 2, and illustrating illumination of a water bottle and the contents thereof.

### DETAILED DESCRIPTION OF THE PREFERRED EMBODIMENT

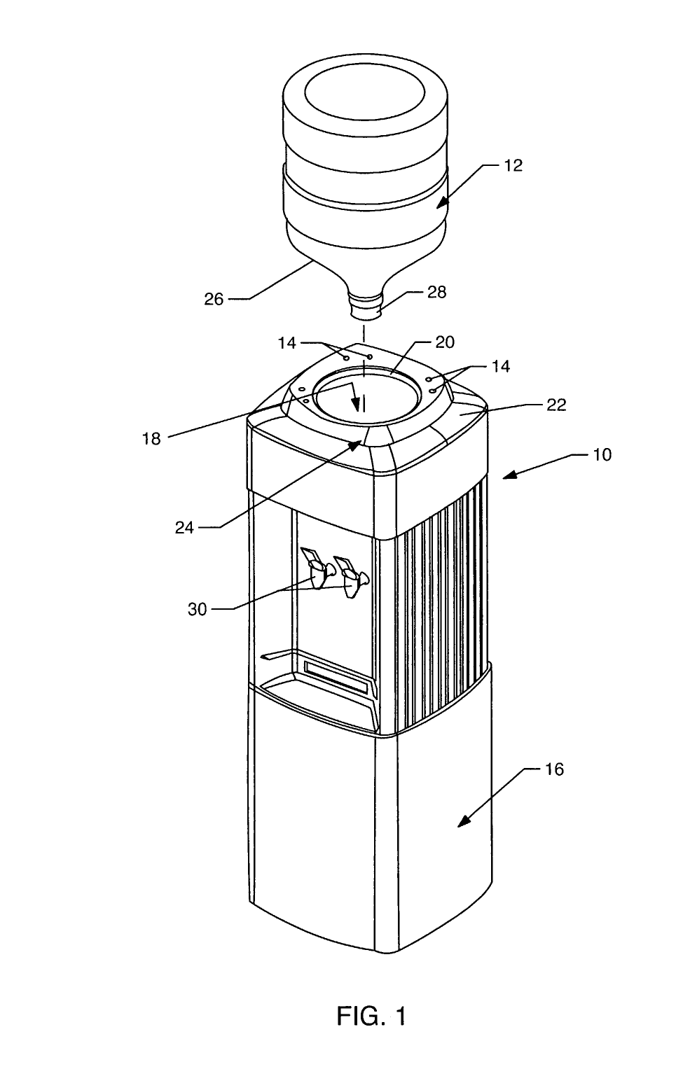

As shown in the exemplary drawings, a bottled water cooler referred to generally in FIG. 1 by the reference numeral 10 is provided for receiving and supporting a water bottle 12 containing a supply of relatively purified water for drinking and cooking uses, etc. The water cooler 10 further includes at least one and preferably a plurality of lights 14 for illuminating the normally transparent bottle structure and the bottle contents to provide the water cooler with a highly attractive, pleasing and refreshing appearance.

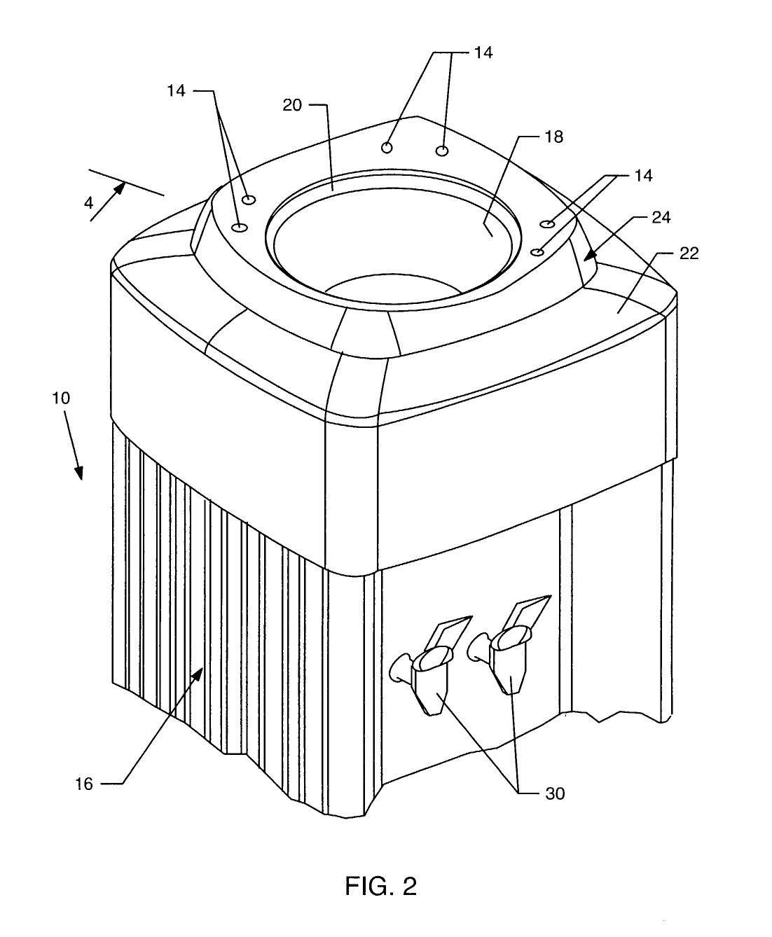

The illustrative bottled water cooler 10 has a generally conventional overall size and shape to include an upstanding housing 16 having an upwardly open reservoir 18 (FIGS. 1 and 2) for receiving and storing water supplied from the bottle 12. In this regard, the reservoir 18 is mounted within an upper region of the cooler housing 16 for exposing the open upper end of the reservoir through a central passage 20 formed in a housing cover or lid 22. FIGS. 2-4 show the housing cover 22 to include a raised or upstanding annular support rim 24 encircling this central passage 20, wherein the support rim 24 is shaped for stable engagement by and support of a contoured and tapered shoulder 26 (FIGS. 1 and 4) extending between an open-mouthed bottle neck and a bottle body of the water bottle 12. The support rim 24 retains the water bottle in an inverted orientation with the open-mouthed bottle neck 28 (FIG. 1) extending downwardly into an upper region of the reservoir 18. Water within the reservoir 18 can be dispensed by means of one or more faucet valves 30 mounted on the front of the cooler housing 16. In this regard, in one common cooler configuration, the reservoir interior may be subdivided into a first chamber associated with refrigeration means (not shown) for chilling the water therein, and a second chamber for maintaining a portion of the water substantially at room temperature, with separate faucet valves 30 being provided for separately dispensing the different-temperature water from the two chambers. Exemplary bottled water coolers of this general type for supporting an inverted water bottle of typically three to five gallon capacity are shown and described in U.S. Pat. Nos. 5,192,004; 5,246,141; 5,390,826; 5,289,951; 5,395,014; 5,297,700; 5,370,276; and 5,927,557 which are incorporated by reference herein.

In normal operation, water contained within the water bottle 12 flows downwardly through the open bottle mouth into the underlying reservoir 18, and the displacement volume of this water downflow is replaced by air drawn upwardly from within the reservoir via the bottle mouth into the bottle interior. This upward air inflow into the bottle takes the form of air bubbles 32 (FIG. 4) passing upwardly through the volume of water 34 remaining in the bottle 12, wherein these air bubbles 32 and the residual water 34 are visible from the exterior through the transparent wall structure 36 of the water bottle 12 formed typically from a blow-molded polycarbonate plastic material. As the water level rises within the reservoir 18, the water level eventually covers the open mouth of the bottle 12 to prevent further air inflow to the bottle. Incremental water downflow following cessation of air intake into the bottle produces a sufficient vacuum within the bottle to correspondingly halt water downflow. Subsequent dispensing of water from the reservoir 18 via one of the faucet valves 30 causes the reservoir water level to descend and uncover the bottle mouth, whereupon the above described water downflow from the bottle and air intake into the bottle resumes until the reservoir water level rises again to cover the bottle mouth. When the bottle 12 reaches an empty condition, the empty bottle is removed from the cooler housing 16 and replaced by a filled water bottle, all in a manner known to persons skilled in the art.

In a preferred arrangement of the invention, a plurality of the lights 14 are mounted in close proximity with the shoulder 26 of the inverted bottle 12 (shown best in FIG. 4), for illuminating the bottle wall structure 36 as well as the residual water 34 within the bottle and any air bubbles 32 passing upwardly through the water. During daytime and/or normal room lighting conditions, this arrangement provides subtle illumination of the bottle 12 and its contents to provide the water cooler 10 with a highly pleasing and attractive appearance, including imparting a unique and readily visible sparkle to air bubbles 32. During night or low room light conditions, this illumination of the bottle 12 and its contents is significantly more visible, and results in casting a novel array of images and shadows onto adjacent walls and ceiling structures of a building. In either condition, the bottle 12 and its contents has a luminous or glowing character which is perceived by observers as an indication of colder or more refreshing and purer water, thereby tending to encourage observers to drink the water in increased quantities.

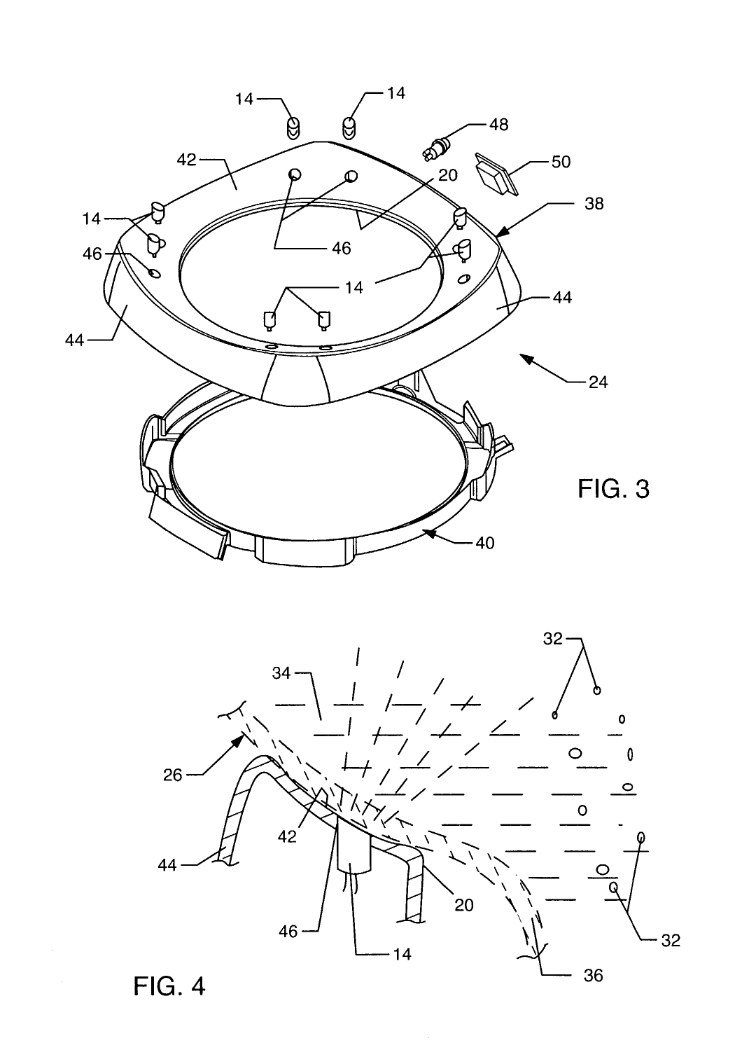

The illustrative drawings show the lights 14 mounted within the support rim 24. More particularly, FIG. 3 shows the support rim 24 to include an upper ring member 38 adapted for assembly as by snap-fit engagement with a mating lower ring member 40 to define a hollow interior within which the plurality of lights 14 are mounted. The upper ring member 38 defines an upper support surface 42 formed with an upwardly concave geometry for matingly engaging and supporting the shoulder 26 (FIG. 4) of the inverted water bottle 12 along an annular or generally annular contact zone. FIGS. 1-3 show this upper support surface 42 terminating at a radially inner margin at the central passage 20 of circular shape, for receiving the open-mouthed bottle neck 28 of the inverted bottle 12 within an upper region of the underlying reservoir 18. A radially outer margin of the upper support surface 42 is shown merging smoothly with a contoured and downwardly projecting outer wall 44 of generally rectangular configuration, whereby the upper support surface 42 defines a somewhat expanded surface area at each of the four corners of the rectangular outer wall. The lower ring member 40 is appropriately connected to the housing cover or lid 22, as by snap-fit engagement therewith or the like.

A pair of light ports 46 is formed within the upper support surface 42 of the support rim 24 generally adjacent each of the four corners of the rectangular outer wall 44. Each of these light ports 46 has one of the lights 14 mounted therein or otherwise mounted to project illumination therethrough. Accordingly, in the illustrative embodiment, a total of eight lights 14 are provided for illuminating the bottle 12 and its contents. However, persons skilled in the art will recognize and appreciate that alternative numbers of the lights 14 and alternative mounting positions may be used.

The illustrative lights 14 comprise, in the preferred form, low voltage light emitting diodes (LED's) each having a light source encased within a compact lens element formed typically from molded plastic. FIGS. 3 and 4 show these lights 14 mounted within the associated lights ports 46, with their respective lens elements each having an angled tip exposed and oriented within the respective port 46 to provide a substantial continuation of the contoured shape of the upper support surface 42. With this configuration, each light 14 is positioned in close proximity to the bottle shoulder 26 (FIG. 4) for providing effective illumination of the bottle wall structure 36 and the bottle contents. As shown in FIG. 3, the assembled support rim 24 may also carry a power connector 48, such as a dc connector, and a control board 50 including appropriate electronic components for suitably powering and controlling the lights 14. In this regard, the lights 14 may be provided in the same or different colors, and may be controllably switched on an off by the control board 50 to provided a further enhanced variable color or twinkling illumination effect.

A variety of modifications and improvements in and to the illuminated water cooler 10 of the present invention will be apparent to those persons skilled in the art. For example, it will be recognized and appreciated that the term water, as used herein, encompasses beverages in general. In addition, it is understood that alternative forms of the lights 14 and alternative mounting arrangements may be used, such as but not limited to one or more optical fibers having ends associated with appropriate lens-type structures for providing a light source, light ropes having one more light sources mounted along the lengths thereof, and other arrangements including lights mounted on or within the water bottle or in close proximity thereto. Moreover, it will be recognized and understood that the invention may be used with water coolers equipped with feed tube adapters designed for opening a valved cap on a water bottle, such as the adapters disclosed in U.S. Pat. Nos. 5,413,152; 5,653,270; and 6,167,921, which are incorporated by reference herein. Still further, it will be recognized and appreciated that the invention may be used with alternative cooler constructions including countertop and ceramic housing arrangements, such as those shown an described in U.S. Pat. No. 6,003,318 which is also incorporated by reference herein. Accordingly, no limitation on the invention is intended by way of the foregoing description and accompany drawings, except as set forth in the appended claims.

What is claimed is:

1. A bottled water cooler, comprising:
an upwardly open reservoir for receiving and storing a supply of water;
dispense means for dispensing water from said reservoir;
support means for supporting a shoulder region of an inverted water bottle to position an open-mouthed bottle neck for supplying water to said reservoir; and
illumination means for illuminating the shoulder region of the supported water bottle.

2. The bottled water cooler of claim 1 wherein said support means comprises a generally annular support rim.

3. The bottled water cooler of claim 2 further including a housing having said reservoir mounted therein, said support rim being carried by said housing.

4. The bottled water cooler of claim 2 wherein said illumination means comprises at least one light mounted on said support rim.

5. The bottled water cooler of claim 2 wherein said at least one light comprises an LED.

6. The bottled water cooler of claim 2 wherein said illumination means comprises a plurality of lights mounted on said support rim.

7. The bottled water cooler of claim 2 wherein said support rim comprises upper and lower ring members adapted for assembly to define a hollow interior, said illumination means comprising a plurality of lights mounted within said hollow interior.

8. The bottled water cooler of claim 7 wherein said upper ring member has a plurality of upwardly open ports formed therein, said plurality of lights being mounted on said support rim for respectively shining through said plurality of ports.

9. The bottled water cooler of claim 8 wherein said upper ring member defines a generally annular support surface for supporting the shoulder region of the inverted water bottle, said annular support surface having said plurality of ports formed therein.

10. The bottled water cooler of claim 1 wherein the water bottle is formed from a transparent material.

11. The bottled water cooler of claim 1 further including control means for regulating operation of said illumination means.

12. In a bottled water cooler having an upwardly open reservoir for receiving and storing a supply of water, dispense means for dispensing water from said reservoir, and a support rim for supporting a water bottle in an inverted orientation on a bottle shoulder with an open-mouthed bottle neck positioned for supplying water to said reservoir, a bottle illumination system, comprising at least one light mounted on said support rim for illuminating the supported shoulder of a water bottle.

13. The bottle illumination system of claim 12 wherein said at least one light comprises an LED.

14. The bottle illumination system of claim 12 wherein said at least one light comprises a plurality of lights mounted on said support rim.

15. The bottle illumination system of claim 12 wherein said support rim comprises upper and lower ring members adapted for assembly to define a hollow interior, said at least one light comprising a plurality of lights mounted within said hollow interior.

16. The bottle illumination system of claim 15 wherein said upper ring member has a plurality of upwardly open ports formed therein, said plurality of lights being mounted on said support rim for respectively shining through said plurality of ports.

17. The bottle illumination system of claim 16 wherein said upper ring member defines a generally annular support surface for supporting the shoulder region of the inverted water bottle, said annular support surface having said plurality of ports formed therein.

18. In combination:
a transparent water bottle having an open-mouthed neck at an upper end thereof, and a contoured tapered shoulder extending between said neck and a bottle body; and
a bottled water cooler having an upwardly open reservoir for receiving and storing a supply of water, dispense means for dispensing water from said reservoir, a support rim for supporting a water bottle in an inverted orientation on a bottle shoulder with an open-mouthed bottle neck positioned for supplying water to said reservoir, and at least one light mounted on said support rim for illuminating the supported shoulder of a water bottle.

19. The combination of claim 18 wherein said at least one light comprises an LED.

20. The combination of claim 18 wherein said at least one light comprises a plurality of lights mounted on said support rim.

21. The combination of claim 18 wherein said support rim comprises upper and lower ring members adapted for assembly to define a hollow interior, said at least one light comprising a plurality of lights mounted within said hollow interior.

22. The combination of claim 21 wherein said upper ring member has a plurality of upwardly open ports formed therein, said plurality of lights being mounted on said support rim for respectively shining through said plurality of ports.

23. The combination of claim 22 wherein said upper ring member defines a generally annular support surface for supporting the shoulder region of the inverted water bottle, said annular support surface having said plurality of ports formed therein.
